(19) United States
(12) Patent Application Publication
(10) Pub. No.: US 2010/0252484 A1
(43) Pub. Date: Oct. 7, 2010

(54) PROCESS FOR PREPARING HIGH ATTRITION RESISTANT INORGANIC COMPOSITIONS AND COMPOSITIONS PREPARED THEREFROM

(76) Inventors: Ranjit Kumar, Clarksville, MD (US); Bryden J. Kenneth, Ellicott City, MD (US)

Correspondence Address: W.R. GRACE & CO.-CONN., 7500 GRACE DRIVE, COLUMBIA, MD, 21044, US

(21) Appl. No.: 12/745,722

(22) PCT Filed: Dec. 18, 2008
(86) PCT No.: PCT/US08/13856

§ 371 Date: Jun. 2, 2010

Related U.S. Application Data
(60) Provisional application No. 61/008,368, filed on Dec. 20, 2007.

(51) Int. Cl. C10G 11/05; B01J 29/06

(52) U.S. Cl. 208/120.15; 502/65

(57) ABSTRACT

A process for the production of high attrition resistant inorganic compositions is provided. The formation of highly attrition resistant compositions is accomplished by forming a slurry of inorganic components, a binder, and optionally clay and matrix materials, milling the slurry, and cooling the milled slurry to a temperature below 17° C., preferably below 10° C. The cooled slurry is subjected to spray-drying, and optionally calcining and/or washing, to provide highly attrition resistant inorganic particles. Catalytic cracking catalysts formed by the process are also disclosed.

### FIELD OF THE INVENTION

The present invention relates to a novel process of preparing high attrition resistant inorganic compositions, in particularly inorganic catalyst compositions, and to high attrition resistant compositions obtainable by the process.

### BACKGROUND OF THE INVENTION

Particulate inorganic catalyst compositions generally comprise small microspherodial particles of inorganic metal oxides bound with a suitable binder. For example, a hydrocarbon conversion catalyst, e.g. fluid catalytic cracking (FCC) catalyst, typically comprises crystalline zeolite particles, and optionally clay particles and matrix materials (e.g. alumina, silica and silica-alumina particles), bound by a binder. Suitable binders have included silica, alumina, silica-alumina, hydrogel, silica sol and alumina sol binder.

Particulate inorganic catalyst compositions have been described and disclosed in various patents. U.S. Pat. Nos. 3,957,689 and 5,135,756 disclose a sol based FCC catalyst comprising particles of zeolite, alumina, clay and a silica sol binder.

A important characteristic of particulate inorganic catalyst compositions is that the compositions have good resistance against attrition. Attrition is a broad term denoting the unwanted break down or abrasion of particles during use in a desired catalytic process. Generally, there is the “break up” of big particles into smaller particles, as well as the abrasion at the edge of particles which create more “fines”.

The preparation of attrition resistant catalyst have been disclosed in several prior art documents.

For example, U.S. Pat. Nos. 4,086,187 and 4,206,085 disclose particulate catalyst compositions containing silica, alumina and clay components wherein the alumina has been peptized with an acid.

U.S. Pat. No. 4,458,023 discloses zeolite containing particulate catalysts prepared from zeolite, an aluminum chlorohydrol binder, and optionally, clay.

U.S. Pat. Nos. 4,480,047 and 4,219,406 disclose particulate catalyst compositions bound with a silica alumina hydrogel binder system.

WO 99/21651 describes a method for making molecular sieve catalyst that is considered relatively hard. The method includes the steps of mixing together a molecular sieve and an alumina sol, the alumina sol being made in solution and matainined at a pH of 2 to 10. The mixture is then spray-dried and calcined. The calcined product is reported to be relatively hard.

WO 2006/048421 A1 discloses an attrition resistant catalyst comprising a catalytically active component, a carrier and optionally a catalyst promoter.

U.S. Patent Application No. 60/818,829, filed on Jul. 6, 2006, discloses catalytic cracking catalyst compositions having good attrition resistance and comprising zeolites, optionally, clay and matrix materials, bound by an alumina binder obtained from aluminum sulfate.

New processes requiring catalyst, catalyst additive and catalyst support materials are constantly being developed in various industries. The ability of these materials to endure the stresses of the process systems promotes the effective life span of the catalysts in a given reaction process. If the materials are not properly attrition resistant, they would be effective for only a relatively short period of time causing increased economic concerns.

Consequently, there remains a need for simple and economic processes for obtaining particulate inorganic compositions, in particular inorganic catalyst compositions, having improved attrition resistant properties.

### SUMMARY OF THE INVENTION

The present invention is directed to a novel process for producing highly attrition resistant particulate inorganic compositions. In general, the process of the present invention comprises forming a slurry of desired inorganic components, milling the slurry, chilling or cooling the slurry and thereafter spray-drying the chilled slurry to form particles. It has been discovered that lowering the temperature of a slurry feed prior to introducing the feed into the spray dryer improves the attrition properties of the resulting particles.

Highly attrition resistant particulate compositions which comprise a plurality of inorganic particles bound with an inorganic binder are provided by the process of the present invention. Particulate compositions of the invention are preferably useful as catalyst compositions. Generally, the particulate catalyst compositions comprise inorganic metal oxide catalyst components, clay and an inorganic binder. In a preferred embodiment of the invention, the particulate compositions are fluid catalytic cracking (FCC) catalyst compositions which generally comprise particles of zeolite, clay, and optionally matrix materials, bound with an inorganic binder. Advantageously, particulate compositions, e.g. FCC catalyst compositions, of the invention exhibit increased attrition resistance as compared to compositions obtained using conventional spray-drying techniques.

Particulate compositions of the invention are generally prepared by forming a liquid slurry comprising a plurality of inorganic particles, and optionally clay and matrix materials, and a sufficient amount of an inorganic binder material to bind the inorganic particles and form an inorganic particulate material. The slurry is then cooled to a temperature of less than 17° C. The cooled slurry is thereafter spray-dried to form particulate inorganic compositions having increased attrition resistance.

Accordingly, it is an advantage of the present invention to provide a simple and economical process for the production of particulate inorganic compositions having increased attrition resistant properties.

It is also an advantage of the present invention to provide an improved spray-drying process for the production of highly attrition resistant inorganic compositions.

It is another advantage of the present invention to provide particulate inorganic compositions having high attrition resistant properties.

It is another advantage of the present invention to provide high attrition resistant particulate inorganic compositions produced by a spray-drying process.

It is also an advantage of the present invention to provide particulate inorganic compositions having increased attrition resistant properties as compared to inorganic compositions prepared using a conventional spray-drying technique.

It is another advantage of the present invention to provide inorganic catalyst compositions having high attrition resistant properties.

It is another advantage of the present invention to provide fluid catalytic cracking catalyst and catalyst additive compositions having high attrition resistant properties.

Another advantage of the present invention is to provide a process for the preparation of fluid catalytic cracking catalyst compositions having high attrition resistance under catalytic cracking conditions.

It is a further advantage of the present invention to provide a process of preparing high attrition resistant particulate inorganic metal oxide compositions bound with a binder.

It is a further advantage of the present invention to provide an economical process of preparing particulate inorganic metal oxide catalyst compositions having improved attrition resistance.

It is also an advantage of the present invention to provide an improved processes for the preparation of high attrition resistant compositions.

Yet another advantage of the present invention is to provide high attrition resistant compositions produced by an improved spray-drying process.

These and other aspects of the present invention are described in further details below.

### DETAILED DESCRIPTION OF THE INVENTION

In accordance with the present invention, the process generally comprises forming a slurry containing a plurality of particulate inorganic components bound with an inorganic binder. In a preferred embodiment of the invention the inorganic components comprise inorganic metal oxide particles, most preferably, the inorganic components are refractory inorganic metal oxide particles. The slurry may be formed by mixing the inorganic components and a binder material, and optionally clay and matrix material, directly into a liquid solution. Alternatively, a slurry comprising at least one binder material and/or inorganic component may be prepared and combined with one or more slurry/ies comprising one or more inorganic component, clay and/or matrix material.

The liquid solution used to form the slurry is preferably an aqueous solution. Small amounts of organic liquids, e.g. methanol or ethanol, may optionally be present in the aqueous solution. The slurry may be mixed using a batch or a continuous mixing process.

The slurry containing the inorganic components, binder and optionally, clay and matrix materials may be milled to obtain a homogeneous or substantially homogeneous slurry and to ensure that all solid components of the slurry have an average particle size of less than about 15 microns. Preferably the solid components of the slurry will have an average particle size of from about 0.1 to about 10 microns. Where individual slurries of components are formed, the slurries may be separately milled prior to combining or the combined slurry may be milled after combining to obtain the desired homogeneity. Alternatively, the desired homogeneity in the slurry may be obtained by milling one or more of the components of the aqueous slurry prior to forming the slurry.

The aqueous slurry is then cooled to a temperature of less than 17° C., preferably less than 15° C., most preferably less than 10° C. In a preferred embodiment of the invention, the slurry is cooled to a temperature ranging from about 1 to about 17° C., preferably from about 2 to about 12° C., most preferably from about 4 to about 10° C. Adjusting the temperature to cool the slurry may be accomplished using conventional cooling means, for example, by using a heat exchanger or an ice bath.

The cooled slurry is thereafter subjected to spray drying using conventional spray drying techniques. In a preferred embodiment of the invention, the cooled slurry is subjected to spray drying using a sprayer dryer having an inlet temperature of about 300° C. to about 700° C., preferably, about 350° C. to about 450° C.

Following spray drying, the particulate compositions are optionally calcined and/or washed. Generally, the particulate compositions are calcined at temperatures ranging from about 150° C. to about 800° C. for a period of about 2 hours to about 10 minutes. The particulate compositions may be washed, typically with an aqueous solution, to remove unwanted ions.

For example, particulate compositions of the invention may be treated by ion exchange to remove any unwanted ion and introduce desired ions. The ion exchange step is typically conducted using water and/or aqueous ammonium salt solutions, such as ammonium sulfate solution, and/or solutions of polyvalent metals such as rare earth solutions, transition metal solutions, and alkaline earth solutions. Typically, these ion exchange solutions contain from about 0.1 to about 30 weight percent dissolved salts. Frequently, it is found that multiple exchanges are beneficial to achieve the desired degree of alkali metal oxide removal. Typically the exchanges are conducted at temperatures on the order of from about 50° to about 100° C.

Subsequent to ion exchange and/or washing, the particulate compositions may be dried, typically at temperatures ranging from about 100° C. to about 600° C. to lower the moisture content thereof to a desirable level, typically below about 30 percent by weight.

Inorganic materials useful as the inorganic components to prepare the compositions of the present invention may be any inorganic metal oxide materials having the sufficient properties and stability depending upon the intended use of the final composition. In general, the inorganic materials are inorganic metal oxides. Suitable inorganic metal oxide materials include those selected from the group consisting of silica, alumina, silica-alumina, oxides of transition metals selected from Groups 3, 4, 5, 6, 7, 8, 9, 10, 11, 12 according to the New Notations of the Periodic Table, oxides of rare earths, oxides of alkaline earth metals, molecular sieves, zeolites and mixtures thereof. Preferred transition metal oxides include, but are not limited to, oxides of iron, zinc, vanadium and mixtures thereof. Preferred oxides of rare earths include, but are not limited to, ceria, yttria, lanthana, praesodemia, neodimia and mixtures thereof. Preferred oxides of alkaline earth include, but are not limited to, oxides of calcium, magnesium and mixtures thereof.

The term “molecular sieve” is used herein to designate a class of polycrystalline materials that exhibits selective sorption properties which separates components of a mixture on the basis of molecular size and shape differences, and have pores of uniform size, i.e., from about 3 Å to approximately 100 Å, which pore sizes are uniquely determined by the unit structure of the crystals. Materials such as activated carbons, activated alumina and silica gels are specifically excluded since they do not possess an ordered crystalline structure and consequently have pores of a non-uniform size. The distribution of the pore diameters of such material may be narrow (generally from about 20 Å to about 50 Å) or wide (ranging from about 20 Å to several thousand Å) as in the case for some activated carbons. See R. Szostak, Molecular Sieves: Principles of Synthesis and Identification, pp. 1-4 and D. W. Breck, Zeolite Molecular Sieves, pp. 1-30. A molecular sieve framework is based on an extensive three-dimensional network of oxygen atoms containing generally tetrahedral type-sites. In addition to the Si⁺⁴ and Al⁺³ that compositionally define a zeolite molecular sieves, other cations also can occupy these sites. These need not be iso-electronic with Si⁺⁴ or Al⁺³, but must have the ability to occupy framework sites. Cations presently known to occupy these sites within molecular sieve structures include but are not limited to Be, Mg, Zn, Co, Fe, Mn, Al, B, Ga, Fe, Cr, Si. Ge, Mn, Ti, and P. Another class of materials intended to fall within the scope of molecular sieve includes mesoporous crystalline materials exemplified by the MCM-41 and MCM-48 materials. These mesoporous crystalline materials are described in U.S. Pat. Nos. 5,098,684; 5,102,643; and 5,198,203.

As will be understood by one skilled in the arts, the amount of a given inorganic metal oxide material used to prepare the compositions of the invention will vary depending upon the intended use of the final composition. When the compositions of the invention are used as a catalytic cracking catalyst, the inorganic metal oxide material may comprise a zeolite as described hereinbelow.

Binder materials useful in the process of the present invention include any inorganic binder that acts like glue, binding together the inorganic components to form a particles. Non-limiting examples of binders that can be used in this invention included silica, alumina, silica-alumina, various types of inorganic oxide sols such as sols of alumina or silica, and mixtures thereof. In a preferred embodiment of the invention the binder is an alumina binder. Preferably the alumina binder is aluminum chlorohyrol, an acid or base peptized alumina, or a precipitated alumina, preferably a precipitated alumina obtained from alumina sulfate as disclosed and described in U. S. Patent Application No. 60/818,829, filed on Jul. 6, 2006, herein incorporated by reference.

The amount of binder used in an inorganic composition will vary depending on such factors as the components comprising the compositions, the intended use of the compositions, and the type of binder used. Typically, particulate inorganic compositions of the invention will comprises from about 5 wt % to about 80 wt % of the binder material. For example, where the binder is a peptized alumina binder, particulate inorganic compositions of the invention will comprises from about 10 wt % to about 80 wt %, preferably about 20 wt % to about 40 wt %, of the binder material. Where the binder is aluminum chlorohydrol, particulate inorganic compositions of the invention will comprise from about 5 wt % to about 30 wt %, preferably about 10 wt % to about 20 wt %, of the binder material. Where the binder is a silica sol, particulate inorganic compositions of the invention will comprise from about 5 wt % to about 25 wt %, preferably about 12 wt % to about 20 wt %, of the binder material. Where the binder is a precipitated alumina obtained from aluminum sulfate, particulate inorganic compositions of the invention will comprise from about 5 wt % to about 15 wt %, preferably about 7 wt % to about 12 wt %, of the binder material. It is also contemplated that the binder may comprise a mixture, for example, about 1 to about 15 wt % aluminum chlorohydrol and 5 wt % to about 40 wt % peptized alumina.

Optional clay components useful in the process of the invention include, but are not limited to, any natural or synthetic clay. Naturally occurring clays or modified natural occurring clays, e.g., partially dried or dehydrated, milled or micronized, or chemically treated are preferred. Such naturally occurring clays include clays from the kaolinite group, the mica group, the smectite group, and the chorite group. Examples of Laolinite group clays include kaolinite, dickite and halloysite. Examples of the mica group clays include muscovite, illite, glauconite and biotite. Examples of the smectite group include montnorillonite and vermiculite. Examples of the chlorite group include penninite, clinochlore, ripidolite and chamosite. Mixed layer clays can also be used.

Suitable matrix materials optionally used in the process of the present invention include alumina, silica, silica-alumina, and oxides of rare earth metals, oxides of transition metals selected from Groups 3, 4, 5, 6, 7, 8, 9, 10, 11, 12 of the New Notations of the Periodic Table, oxides of alkaline earth metals and mixtures thereof.

It is further within the scope of the present invention that the particulate compositions of the invention may be used in combination with other additives typically used in the intended process, for example SOₓ reduction additives, NOₓ reduction additives, gasoline sulfur reduction additives, CO combustion promoters, additives for the production of light olefins, and the like.

As will be understood by one skilled in the arts, particulate inorganic compositions in accordance with the invention will have varying particle sizes depending on the intended use. Typically, however, the particulate compositions of the invention will have an average particle size ranging from about 40 to about 120 microns, preferably from 60 about to 100 about microns.

Particulate inorganic compositions of the invention exhibit a high degree of attrition resistance as measured by the Davison Attrition Index (DI) which is described as follows:

Following calcination in a muffle furnace for two hours at 538° C., a 7.0 g sample of catalyst is screened to remove particles in the 0 to 20 micron size range. The particles above 20 microns are then subjected to a 1 hour test in a standard Roller Particle Size Analyzer using a hardened steel jet cup having a precision bored orifice. An air flow of 21 liters a minute is used. The Davison Index is calculated as follows:

$$Davison Index = \frac{Wt . \% 0 \text{-} 20 micron material formed during test}{Wt . Original 20 + micron fraction}$$

Advantageously, inorganic compositions in accordance with the present invention have an increased attrition resistance as compared to corresponding inorganic compositions prepared without cooling the aqueous slurry prior to spray drying. Typically, compositions in accordance with the invention have a DI of less than 30, preferably less than 20, most preferably less than 15.

Particulate compositions in accordance with the invention may be useful in the preparation of various catalysts including, but not limited to, fluid catalytic cracking catalyst, hydroprocessing catalysts, hydrogenation catalysts, alkylation catalysts, reforming catalysts, gas-to-liquid conversion catalysts, coal conversion catalysts, hydrogen manufacturing catalysts, hydrocarbon synthesis catalysts and automotive catalysts. Particulate compositions of the invention may also be useful to prepare various catalyst additives, such as for example, fluid catalytic cracking additives e.g. as SOₓ reduction and NOₓ reduction additives.

In a preferred embodiment of the invention, the particulate compositions of the invention are useful as a catalytic cracking catalyst. In a more preferred embodiment, compositions of the invention are useful as fluid catalytic cracking (FCC) catalysts. When used as a FCC catalyst, particulate compositions of the invention will typically comprise a zeolite, a binder, one or more matrix of silicas, aluminas and/or silica aluminas, and fillers such as kaolin clay.

The zeolite component useful to prepare FCC catalyst in accordance with the present invention may be any zeolite which has catalytic cracking activity under fluid catalytic cracking conditions. Typically the zeolitic component is a synthetic faujasite zeolite such as sodium type Y zeolite (NaY) that contains from about 10 to about 15 percent by weight Na₂O. Alternatively, the faujasite zeolite may be a USY or REUSY faujasite zeolite. It is contemplated within the scope of the present invention that the zeolite component may be hydrothermally or thermally treated before incorporation into the catalyst. It is also contemplated that the zeolites may be partially ion exchanged to lower the soda level thereof prior to incorporation in the catalyst. Typically, the zeolite component may comprise a partially ammonium exchanged type Y zeolite NH₄NaY which will contain in excess of 0.2 percent and more frequently from about 0.8 to about 6 percent by weight Na₂O. Furthermore, the zeolite may be partially exchanged with polyvalent metal ions such as rare earth metal ions, iron, zinc, vanadium, calcium, magnesium and the like. The zeolite may be exchanged before and/or after thermal and hydrothermal treatment. The zeolite may also be exchanged with a combination of metal and ammonium and/or acid ions. It is also contemplated that the zeolite component may comprise a mixture of zeolites such as synthetic faujasite in combination with mordenite, Beta zeolites and ZSM type zeolites. Generally, the zeolite cracking components comprises from about 5 to about 80 wt % of the cracking catalyst. Preferably the zeolitic cracking components comprises from about 10 to about 70 wt %, most preferably, from about 20 wt % to about 65 wt %, of the catalyst composition.

Suitable binder materials useful to prepare FCC catalyst compositions in accordance with the present invention include, but are not limited to, silica, alumina, silica-alumina, hydrogel, silica sol, alumina sol, precipitated alumina, in particular, a precipitated alumina obtained from aluminum sulfate as disclosed and described in U.S. Patent Application No. 60/818,829, filed on Jul. 6, 2006. Preferably, the binder material is alumina. Most preferably the binder material is aluminum chlorohdryol. Even more preferably, the binder is an acid or base peptized alumina.

Typically, FCC catalyst compositions in accordance with the present invention comprise an amount of binder sufficient to bind the catalyst particle and form particles having a Davison Attrition Index (DI) of less than 30. Preferably, the amount of binder ranges from about 5 wt % to about 80 wt % of the catalyst composition. Most preferably, the amount of binder ranges from about 5 wt % to about 60 wt % of the catalyst composition.

Catalytic cracking catalysts in accordance with the present invention may optionally include clay. While kaolin is the preferred clay component, it is also contemplated that other clays, such as pillared clays and/or modified kaolin (e.g. metakaolin), may be optionally included in the invention catalyst. When used, the clay component will typically comprise up to about 75 wt %, preferably about 10 to about 65 wt %, of the catalyst composition.

Catalytic cracking catalyst compositions of the invention may also optionally comprise at least one or more matrix materials. Suitable matrix materials optionally present in the catalyst of the invention include alumina, silica, silica-alumina, and oxides of rare earth metals and transition metals. The matrix material may be present in the invention catalyst in an amount of up to about 60, preferably about 5 to about 40 wt % of the catalyst composition.

In a preferred embodiment of the present invention, the primary components of FCC catalyst in accordance with the present invention comprise a binder, preferably an alumina sol or peptized alumina, a Y type zeolite component, one or more matrix aluminas and/or silica aluminas, and fillers such as kaolin clay. The Y zeolite may be present in one or more forms and may have been ultra-stabilized and/or treated with stabilizing cations, such as, for example, rare earths.

The particle size and attrition properties of the inorganic particulate compositions of the invention will vary depending on the intended use. For example, where the compositions are catalytic cracking catalyst, the particle size and attrition properties of the catalysts affect fluidization properties in the catalytic cracking unit and determine how well the catalyst is retained in the commercial unit, especially in an FCC unit. When used as a FCC catalyst, compositions of the invention will typically have a mean particle size of about 40 to about 150 μm, more preferably from about 60 to about 120 μm.

Catalytic cracking catalyst compositions in accordance with the present invention are typically prepared as described hereinabove, i.e. by forming a homogeneous or substantially homogeneous slurry aqueous slurry comprising a zeolite, a binder and optionally clay and matrix materials. Preferably, the slurry has an average particle size of less than 15 microns. The slurry is thereafter cooled and spray dried as described hereinabove.

Following spray drying, the catalyst particles are optionally, calcined at temperatures ranging from about 150° C. to about 800° C. for a period of about 2 hours to about 10 minutes, preferably, the catalyst particles are calcined at a temperature ranging from about 250° C. to about 600° C. for about forty minutes, and/or washed, preferably with water.

The catalyst particles may thereafter be optionally ion exchanged. The resulting catalyst particles are separated from the slurry by conventional techniques, e.g. filtration, and may be dried to lower the moisture content of the particles to a desired level, typically at temperatures ranging from about 100° C. to 300° C.

It is further within the scope of the present invention that catalyst compositions of the invention may be used in combination with other additives conventionally used in a catalytic cracking process, e.g. SOₓ reduction additives, NOₓ reduction additives, gasoline sulfur reduction additives, CO combustion promoters, additives for the production of light olefins, and the like.

FCC catalyst compositions of the invention are useful under fluid catalytic cracking conditions to convert hydrocarbon feedstocks into lower molecular weight compounds. For purposes of this invention, the phrase “ fluid catalytic cracking conditions” is used herein to indicate the conditions of a typical FCC process which involves circulating an inventory of cracking catalyst. For convenience, the invention will be described with reference to the FCC process although the present cracking process could be used in the older moving bed type (TCC) cracking process with appropriate adjustments in particle size to suit the requirements of the process.

Apart from the addition of the catalyst composition of the invention to or as the catalyst inventory, the manner of operating the FCC process will remain unchanged. Thus, in combination with the catalyst compositions of the invention, conventional FCC catalysts may be used, for example, zeolite based catalysts with a faujasite cracking component as described in the seminal review by Venuto and Habib, Fluid Catalytic Cracking with Zeolite Catalysts, Marcel Dekker, New York 1979, ISBN 0-8247-6870-1 as well as in numerous other sources such as Sadeghbeigi, Fluid Catalytic Cracking Handbook, Gulf Publ. Co. Houston, 1995, ISBN 0-88415-290-1.

The term “catalytic cracking activity” is used herein to indicate the ability to catalyze the conversion of hydrocarbons to lower molecular weight compounds under catalytic cracking conditions.

Somewhat briefly, the FCC process involves the cracking of heavy hydrocarbon feedstocks to lighter products by contact of the feedstock in a cyclic catalyst recirculation cracking process with a circulating fluidizable catalytic cracking catalyst inventory consisting of particles having a size ranging from about 20 to about 150 μm. The catalytic cracking of these relatively high molecular weight hydrocarbon feedstocks results in the production of a hydrocarbon product of lower molecular weight. The significant steps in the cyclic FCC process are:
(i) the feed is catalytically cracked in a catalytic cracking zone, normally a riser cracking zone, operating at catalytic cracking conditions by contacting feed with a source of hot, regenerated cracking catalyst to produce an effluent comprising cracked products and spent catalyst containing coke and strippable hydrocarbons;
(ii) the effluent is discharged and separated, normally in one or more cyclones, into a vapor phase rich in cracked product and a solids rich phase comprising the spent catalyst;
(iii) the vapor phase is removed as product and fractionated in the FCC main column and its associated side columns to form gas and liquid cracking products including gasoline;
(iv) the spent catalyst is stripped, usually with steam, to remove occluded hydrocarbons from the catalyst, after which the stripped catalyst is oxidatively regenerated in a catalyst regeneration zone to produce hot, regenerated catalyst which is then recycled to the cracking zone for cracking further quantities of feed.

Typical FCC processes are conducted at reaction temperatures of 480° C. to 600° C. with catalyst regeneration temperatures of 600° C. to 800° C. As it is well known in the art, the catalyst regeneration zone may consist of a single or multiple reactor vessels. The compositions of the invention may be used in FCC processing of any typical hydrocarbon feedstock. As will be understood by one skilled in the arts, the useful amount of the invention catalyst compositions will vary depending on the specific FCC process. Typically, the amount of the compositions used is at least 0.1 wt %, preferably from about 0.1 to about 10 wt %, most preferably from about 0.5 to 100 wt % of the cracking catalyst inventory.

Cracking catalyst compositions of the invention may be added to the circulating FCC catalyst inventory while the cracking process is underway or they may be present in the inventory at the start-up of the FCC operation. The catalyst compositions may be added directly to the cracking zone or to the regeneration zone of the FCC cracking apparatus, or at any other suitable point in the FCC process. As will be understood by one skilled in the arts, the amount of catalyst used in the cracking process will vary from unit to unit depending on such factors as the feedstock to be cracked, operating conditions of the FCCU and desired output. Typically, the amount of catalyst used will range from about 1 gm to about 30 gms for every 1 gm of feed. The catalyst of the invention may be used to crack any typical hydrocarbon feedstock.

To further illustrate the present invention and the advantages thereof, the following specific examples are given. The examples are given as specific illustrations of the claimed invention. It should be understood, however, that the invention is not limited to the specific details set forth in the examples.

All parts and percentages in the examples as well as the remainder of the specification that refers to compositions or concentrations are by weight unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited.

### Examples

### Example 1

10,222 g of low soda REUSY powder (TV=14.4%) was slurried with 673 g of lanthanum carbonate (TV=29.4%), 13,158 g of aluminum chlorohydrol (TV=79.1%, alumina=20.9%), 11,749 gms of bohmite alumina (TV=61.7%), 10,029 g (TV=15%) of kaolin clay in 19,958 g of water. The slurry was milled using a DRAIS mill and then the milled slurry was separated into two equal parts: Part A and Part B.

Part A of the milled slurry was heated to 50° C. and then introduced into a spray-dryer having an inlet temperature of 400° C. and spray-dried. The spray-dried material was then calcined at 593° C. for 40 minutes.

Part B of the milled slurry was cooled to 7° C. using an ice bath. The cooled slurry was then introduced into a spray-dryer at an inlet temperature of 400° C. and spray-dried. The spray-dried material was then calcined at 593° C. for 40 minutes.

Properties of the resulting materials are recorded in Table 1 below.

TABLE 1

| | |
|---|---|
| Part A | Part B |

spray dryer feed temperature

| | 50 C. | 7 C. |
|---|---|---|
| Al₂O₃, wt % | 51.8 | 52 |
| Na₂O, wt % | 0.28 | 0.28 |
| SO₄, wt % | 0.5 | 0.5 |
| RE₂O₃, wt % | 3.17 | 3.19 |
| average particle size, micron | 89 | 83 |
| average bulk density, gms/ml | 0.73 | 0.78 |
| DI | 3 | 1 |
| zeolite surface area, m²/gms | 224 | 224 |
| matrix surface area, m^{2/}gms | 62 | 58 |

### Example 2

An aluminum sulfate slurry was prepared as follows: 22,500 gms of aluminum sulfate crystals (TV=83.3, Al₂O₃=16.7%) was dissolved in 23,274 gms of water at 50° C. 59,630 gms of Drais milled aqueous USY slurry (TV=72%) was added to the aqueous aluminum sulfate slurry. The slurry was mixed and stirred for 2 hours. The slurry was then aged for 16 hours. 25,046 gms of kaolin clay (TV=15%) was added to the aged slurry. The slurry was mixed well using a Meyer's Mixer. The resulting slurry was separated into two equal parts: Part A and Part B.

Part A of the slurry at 22° C. was introduced into a spray-dryer having an inlet temperature of 400° C. and spray-dried. The spray-dried material was calcined for 40 minutes at 371° C.

2,100 gms of water was mixed with 330 gms of aqua ammonia at 75° C., and then 700 gms of the calcined catalyst particles were added and stirred for 10 minutes. The slurry was then filtered. The filter cake was rinsed with 75° C. water, then rinsed with a (NH₄)₂SO₄ solution (200 gms of (NH₄)₂SO₄ and 2400 gms of water at 75° C.) and again rinsed with 75° C. water. The material was then exchanged with rare earths, using the rare earths chloride solution, and oven dried.

Part B of the slurry was cooled to a temperature of 7° C. and spray-dried using a spray-dryer having an inlet temperature of 400° C. The spray-dried material was calcined for 40 minutes at 371° C.

2,100 gms of water was mixed with 330 gms of aqua ammonia at 75° C., and 700 gms of the calcined catalyst particles were slurried in the aqueous ammonia solution and stirred for 10 minutes. The slurry was then filtered. The filter cake was rinsed with 75° C. water, then rinsed with a (NH₄)₂SO₄ solution (200 gms of (NH₄)₂SO₄ and 2,400 gms of water at 75° C.) and again rinsed with 75° C. water. The material was then exchanged with rare earths, using the rare earths chloride solution and oven dried.

Properties of the resulting materials are recorded in Table 2 below.

TABLE 2

| | |
|---|---|
| Part A | Part B |

spray dryer feed temperature

| | 22 C. | 7 C. |
|---|---|---|
| Al₂O₃, wt % | 37.6 | 36.9 |
| Na₂O, wt % | 0.21 | 0.18 |
| SO₄, wt % | 1.06 | 1.1 |
| RE₂O₃, wt % | 3.88 | 4.17 |
| average particle size, micron | 79 | 79 |
| average bulk density, gms/ml | 0.68 | 0.69 |
| DI | 21 | 12 |
| zeolite surface area, m²/gms | 224 | 219 |
| matrix surface area, m²/gms | 70 | 70 |

### Example 3

3,750 gms Ludox AS40 (TV=60%) sold by W. R. Grace & Co.-Conn., 50,279 gms of HCl peptized alumina (TV=82.1%), 2,284 gms of rare earth chloride solution (TV=73.7%, RE₂O₃=26.3%), 13,412 gms of kaolin clay (TV=15%) was added to 27,273 gms of an aqueous USY slurry (TV=72.5%). The slurry was DRAIS milled and split into parts two: Part A and Part B.

Part A of the slurry was heated to 52° C. and then spray-dried in a spray-dryer having an inlet temperature of 400° C. The spray-dried material was calcined for 40 minutes at 317° C.

1,022 gms of the calcined catalyst particles were slurried into 3,600 gms of water at 50° C. for 10 minutes. The slurry was then filtered and the resulting filter cake was rinsed with 75° C. water. The filter cake was then re-slurried in 3,600 gms of water at a temperature of 50° C. and a pH of 7.5 (obtained using aqua ammonia) for 10 minutes. The slurry was filtered. The resulting filter cake was rinsed with 75° C. water and oven dried.

Part B of the slurry was cooled 8° C. using an ice bath and then spray-dried in a spray-dryer having an inlet temperature of 400° C. The spray-dried material was calcined for 40 minutes at 317° C.

1,011 gms of the calcined catalyst particles were slurried into 3,600 gms of water at 50° C. for 10 minutes. The slurry was then filtered and the resulting filter cake was rinsed with 75° C. water. The filter cake was then re-slurried in 3,600 gms of water at a temperature of 50° C. and a pH of 7.5 (obtained using aqua ammonia) for 10 minutes. The slurry was filtered. The resulting filter cake was rinsed with 75° C. water and oven dried.

Properties of the resulting materials are recorded in Table 3 below.

TABLE 3

| | |
|---|---|
| Part A | Part B |

spray dryer feed temperature

| | 52 C. | 8 C. |
|---|---|---|
| Al₂O₃, wt % | 49.2 | 49.4 |
| Na₂O, wt % | 0.22 | 0.24 |
| SO₄, wt % | 0.47 | 0.36 |
| RE₂O₃, wt % | 2.11 | 2.23 |
| average particle size, micron | 66 | 61 |
| average bulk density, gms/ml | 0.72 | 0.76 |
| DI | 9 | 6 |
| zeolite surface area, m²/gms | 172 | 167 |
| matrix surface area, m²/gms | 117 | 121 |

We claim:

1. A process for preparing a high attrition resistant particulate inorganic composition, said process comprising
a) forming an aqueous slurry comprising a plurality of inorganic particles and an inorganic binder in an amount sufficient to bind the metal oxide particles and form particles;
b) cooling the slurry to a temperature of less than 17° C.; preferably less than 10° C.
c) spray-drying the slurry to form inorganic metal oxide particles bound by an inorganic binder material;
d) recovering an inorganic metal oxide composition having a Davison Index of less than 30.

2. (canceled)

3. (canceled)

4. The process of claim 1 wherein the slurry is cooled to a temperature ranging from about 1° C. to about 16° C.; preferably about 2° C. to about 12° C.

5. (canceled)

6. The process of claim 1 wherein the inorganic metal oxide is selected from the group consisting of molecular sieves, zeolites, silica, alumina, silica-alumina, oxides of a transitions metal, oxides of a rare earth, oxides of an alkaline earth metal and mixtures thereof.

7. The process of claim 6 wherein the transition metal is selected from the group consisting of iron, zinc, vanadium and mixtures thereof.

8. The process of claim 6 wherein the rare earth is selected from the group consisting of ceria, yttria, lanthana, praesodemia, neodimia and mixtures thereof.

9. The process of claim 6 wherein the alkaline earth metal is selected from the group consisting of calcium, magnesium and mixtures thereof.

10. The process of claim 1 wherein the inorganic binder is selected from the group consisting of silica, alumina, silica-alumina, and mixtures thereof.

11. The process of claim 10 wherein the inorganic binder is alumina.

12. The process of claim 11 wherein the alumina is a peptized alumina.

13. The process of claim 10 wherein the alumina is a precipitated alumina obtained from alumina sulfate.

14. The process of claim 10 wherein the alumina is aluminum chlorohydrol.

15. The process of claim 1 where in the slurry of step (a) further comprises clay.

16. The process of claim 1 wherein the slurry of step (a) further comprises a matrix material selected from the group consisting of silica, alumina, silica-alumina, oxides of rare earth metals, oxides of a transition metal and mixtures thereof.

17. (canceled)

18. The process of claim 1 wherein the cooled slurry is spray-dried at a spray-dryer inlet temperature of ranging from about 300° C. to about 700° C.

19. The process of claim 1 further comprising milling the aqueous slurry of step
(a) prior to cooling.

20. The process of claim 1 or 19 further comprising calcining the spray-dried inorganic metal oxide particles.

21. A spray-dried particulate composition comprising an inorganic metal oxide component bound with an inorganic binder wherein the composition is prepared by
a) forming an aqueous slurry comprising a plurality of inorganic oxide particles and an inorganic binder in an amount sufficient to bind the metal oxide particles and form particles;
b) cooling the slurry at a temperature of less than 17° C.; preferably less than 10° C.
c) spray-drying the slurry to form particles bound by an inorganic binder material;
d) recovering a particulate inorganic metal oxide composition having a Davison Index of less than 30, preferably less than 20.

22. (canceled)

23. (canceled)

24. The composition of claim 21 wherein the temperature of step (c) ranging from about 1° C. to about 16° C.

25. The composition of claim 21 wherein the inorganic metal oxide is selected from the group consisting of silica, alumina, silica-alumina, oxides of a transitions metal, oxides of a rare earth, oxides of an alkaline earth metal, and mixtures thereof.

26. The composition of claim 25 wherein the transition metal is selected from the group consisting of iron, zinc, vanadium and mixtures thereof.

27. The composition of claim 25 wherein the rare earth is selected from the group consisting of ceria, yttria, lanthana, praesodemia, neodimia and mixtures thereof.

28. The composition of claim 25 wherein the alkaline earth metal is selected from the group consisting of calcium, magnesium and mixtures thereof.

29. The composition of claim 21 wherein the inorganic binder is selected from the group consisting of silica, alumina, silica-alumina, sols of alumina, sols of silica and mixtures thereof.

30. The composition of claim 29 wherein the inorganic binder is alumina.

31. The composition of claim 30 wherein the alumina is a peptized alumina.

32. The composition of claim 30 wherein the alumina is a precipitated alumina.

33. The composition of claim 32 wherein the precipitated alumina is obtained from aluminum sulfate.

34. The composition of claim 29 wherein the alumina sol is aluminum chlorohydrol.

35. The composition of claim 21 wherein the composition further comprises clay.

36. The composition of claim 21 wherein the composition further comprises a matrix material selected from the group consisting of silica, alumina, silica-alumina, oxides of rare earth metals, oxides of a transition metal and mixtures thereof.

37. The composition of claim 21 wherein the cooled slurry is spray-dried at an inlet temperature of ranging from about 300° C. to about 700° C.

38. (canceled)

39. (canceled)

40. The composition of claim 21 wherein the inorganic binder is present in the slurry in an amount ranging from about 5 wt % to about 80 wt % of the catalyst composition in the final catalyst composition.

41. A method of forming a catalytic cracking catalyst composition having a high attrition resistance, said method comprising
a) forming an aqueous slurry comprising at least one zeolite particle having catalytic cracking activity under catalytic cracking conditions and an alumina binder in amount sufficient bind the zeolite particles to form particles;
b) cooling the slurry to a temperature of less than 17° C.; preferably less than 10° C.
c) spray drying the cooled slurry to form particles; and
d) recovering a particulate catalyst having a Davison Index of less than 30.

42. (canceled)

43. (canceled)

44. The method of claim 41 wherein the slurry is cooled to a temperature ranging from about 1° C. to about 16° C.

45. The method of claim 41 wherein the at least one zeolite comprise faujasite zeolite.

46. The method of claim 45 wherein the faujasite zeolite is selected from the group consisting of Y-type zeolite, USY zeolite, REUSY zeolite, or a mixture thereof.

47. The method of claim 46 wherein the zeolite is partially exchanged with ions selected from the group consisting of rare earth metals ions, transition metals, alkaline earth metal ions, ammonium ions, acid ions and mixtures thereof

48. The method of claim 41 wherein the slurry further comprises clay.

49. The method of claim 41 or 48 wherein the slurry further comprises at least one matrix material selected from the group consisting of alumina, silica, silica-alumina, oxides of transition metals selected from Groups 3, 4, 5, 6, 7, 8, 9, 10, 11, 12 of the New Notations of the Periodic Table, oxides of rare earth metals, oxides of alkaline earth metals and mixtures thereof.

50. The method of claim 41 further comprising milling the aqueous slurry prior to cooling.

51. The method of claim 50 further comprising calcining the spray-dried particles.

52. A method of catalytic cracking a hydrocarbon feedstock into lower molecular weight components, said method comprising contacting a hydrocarbon feedstock with a catalytic cracking catalyst at elevated temperature whereby lower molecular weight hydrocarbon components are formed, said cracking catalyst comprising the composition of claim 41, 45, 48 or 49.

53. The method of claim 52 further comprising recovering the cracking catalyst from said contacting step and treating the used catalyst in a regeneration zone to regenerate said catalyst.

54. The method of claim 52 wherein the method is a fluid catalytic cracking process.

55. A catalytic cracking catalyst formed by the method of claim 41, 45, 48 or 49.

56. The process of claim 1 or 19 further comprising washing the spray-dried inorganic metal oxide particles.

57. The process of claim 20 further comprising washing the calcined inorganic metal oxide particles.

58. The composition of claim 21 wherein the aqueous slurry is milled prior to cooling.

59. The composition of claim 21 or 58 wherein the spray-dried particles are calcined at a temperature ranging from about 150° C. to 800° C.

60. The composition of claim 21 or 58 wherein the spray-dried particles are washed with an aqueous solution.

61. The composition of claim 59 wherein the calcined particles are washed with an aqueous solution.

62. The method of claim 41 or 50 further comprising washing the spray-dried particles.

63. The method of claim 51 further comprising washing the calcined particles.
